(19) United States
(12) Patent Application Publication
(10) Pub. No.: US 2012/0262117 A1
(43) Pub. Date: Oct. 18, 2012

(54) CHARGING SYSTEM

(75) Inventors: Roman S. Ferber, West Bloomfield, MI (US); Jeff Wollenzien, Toronto (CA); John Liu, Mississauga (CA); Hing Wah Tsang, Ajax (CA)

(73) Assignee: FKA DISTRIBUTING CO., D/B/A HOMEDICS, INC., Commerce Township, MI (US)

(21) Appl. No.: 13/347,132

(22) Filed: Jan. 10, 2012

Related U.S. Application Data
(63) Continuation-in-part of application No. 13/089,001, filed on Apr. 18, 2011.

(51) Int. Cl. H02J 7/00; H02J 7/02

(52) U.S. Cl. 320/111; 320/107

(57) ABSTRACT

A portable system for charging an electronic device has a charging system located within a bag, and an audio notification module for indicating a charging status of at least one of the battery charging system and the electronic device. Another portable system has a charging system located within a bag with a charging port accessible from an exterior of the bag. A charging apparatus is configured to connect to the charging port through the bag to provide power to the charging system. Yet another portable system has a charging system located within a bag with a battery check button accessible from an exterior of the bag and lights visible from an exterior of the bag. Upon activation of the battery check button by a user, a light module is configured to illuminate the lights to provide information regarding a state of charge of the charging system.

### CROSS-REFERENCE TO RELATED APPLICATIONS

This application is a continuation-in-part of U.S. application Ser. No. 13/089,001 filed Apr. 18, 2011, the disclosure of which is incorporated in its entirety by reference herein.

### TECHNICAL FIELD

Various embodiments relate to charging systems having a battery for use with luggage and bags, and the bags and luggage pieces containing the systems.

### BACKGROUND

Electronic devices have become smaller and more mobile, and the number of electronic devices that a person carries with them has greatly increased in the last few years. Electronic devices include mobile telephones, personal digital assistants, tablets, e-readers, laptops, cameras, portable navigation systems, personal digital music players, handheld game consoles, and the like. Some of the mobile devices have removable rechargeable batteries where the battery is placed into a docking station to be recharged, or alternatively is recharged while located within the device. Others have internal rechargeable batteries which are recharged while located within the device.

### SUMMARY

In an embodiment, a portable system for charging an electronic device is provided with a bag and a charging system located within the bag. At least one cord has a connector in electrical communication with the charging system. The connector is for charging an electronic device. An audio notification module is in communication with the charging system for indicating a charging status of at least one of the charging system and the electronic device.

In another embodiment, a portable system for charging an electronic device is provided with a bag and a charging system located within the bag. The charging system has a charging port accessible from an exterior of the bag. A charging apparatus has a distal connector configured to plug into an external power supply and a proximal connector configured to connect to the charging port through the bag to provide power to the charging system for charging the charging system. At least one cord has a connector in electrical communication with the charging system. The connector charges an electronic device.

In yet another embodiment, a portable system for charging an electronic device is provided with a bag and a charging system located within the bag. The charging system has a docking station for releasably docking a battery. The charging system includes a battery check button accessible from an exterior of the bag and lights visible from an exterior of the bag. A light module is in communication with the charging system. Upon activation of the battery check button by a user, the light module is configured to illuminate the lights to provide information regarding a state of charge of the charging system. At least one cord has a connector in electrical communication with the charging system. The connector charges an electronic device.

### BRIEF DESCRIPTION OF THE DRAWINGS

FIG. 1 is a perspective view of a bag having a charging system according to an embodiment;

FIG. 2 is a perspective view showing a portion of the interior of the bag of FIG. 1;

FIG. 3 is another perspective view showing a portion of the interior of the bag of FIG. 1;

FIG. 4 is yet another perspective view showing a portion of the interior of the bag of FIG. 1;

FIG. 5 is a perspective view of a charging system according to an embodiment;

FIG. 6 is a perspective view of a power cord for use with the charging system of FIG. 5;

FIG. 7 is a perspective view of a dock of the charging system of FIG. 5;

FIG. 8 is a perspective view of a battery of the charging system of FIG. 5; and

FIG. 9 is a bottom plan view of the battery of FIG. 8;

FIG. 10 is a front plan view of the battery of FIG. 8;

FIG. 11 is a left side plan view of the battery of FIG. 8;

FIG. 12 is right side plan view of the battery of FIG. 8;

FIG. 13 is a top plan view of the battery of FIG. 8;

FIG. 14 is a another perspective view of the battery of FIG. 8;

FIG. 15 is a rear plan view of the battery of FIG. 8;

FIG. 16 is a front plan view of the dock of the charging system of FIG. 7;

FIG. 17 is a bottom plan view of the dock of the charging system of FIG. 7;

FIG. 18 is a top plan view of the dock of the charging system of FIG. 7;

FIG. 19 is a left plan view of the dock of the charging system of FIG. 7;

FIG. 20 is a right plan view of the dock of the charging system of FIG. 7;

FIG. 21 is a perspective view of a bag having a charging system according to another embodiment;

FIG. 22 is a cut-away view of an exterior side panel of the bag of FIG. 21;

FIG. 23 is a cut-away view of an interior charging pocket of the bag of FIG. 21;

FIG. 24 is a perspective view of a retaining pocket for a charging system according to an embodiment;

FIG. 25 is a perspective view of an interior pocket of the bag of FIG. 21;

FIG. 26 is a front plan view of a charging system according to an embodiment;

FIG. 27 is a side elevational view of the charging system of FIG. 26;

FIG. 28 is a side elevational view of a charging system having a larger amperage battery; and

FIG. 29 is a rear plan view of a charging system according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

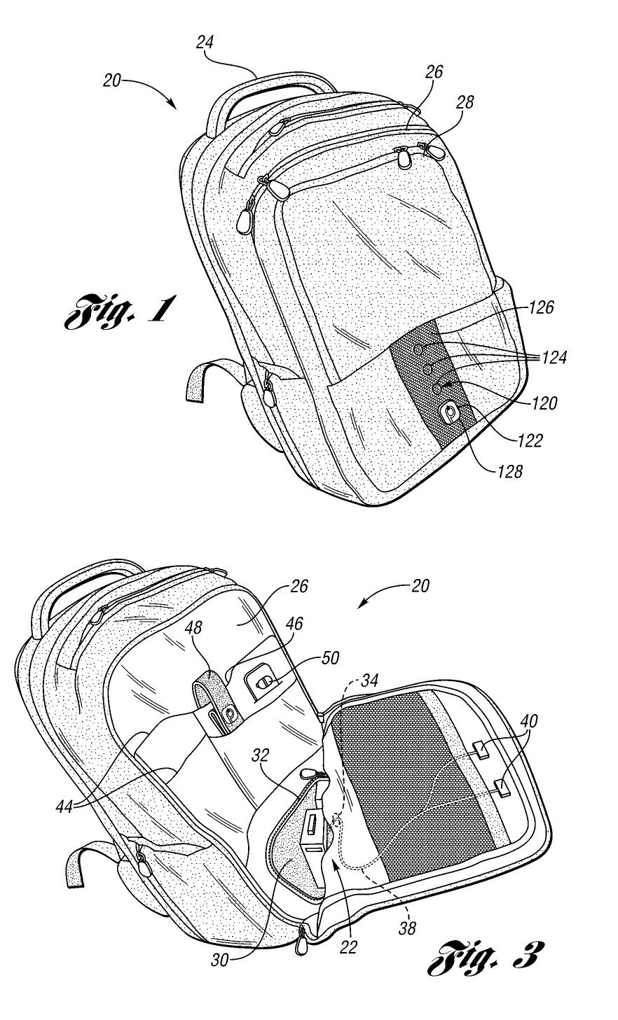

A bag 20 for use with a portable charging system 22 is illustrated in FIGS. 1-4. The bag 20 is shown as a backpack, however, any bag or piece of luggage is contemplated, including handbags, messenger bags, shoulder bags, roller bags, camera bags, and the like. The bag 20 may be constructed from a nylon material, although it is contemplated that the bag 20 may be made from leather, or another synthetic material.

With reference to FIGS. 1 and 2, the bag 20 may include a strap system 24, a pocket 26, and a front pocket 28. The strap system 24 allows the user to carry the bag 20, and can be a backpack style strap, a single over the shoulder strap, a double strap, a handle, or the like. Any number of pockets is contemplated, such as a laptop sleeve, a sunglass pocket, and other storage pockets for books, files, and personal belongings. The pocket 26 has an interior charging pocket 30, as shown in FIG. 3. The charging pocket 30 may be sewn or otherwise affixed into the bottom or a side of the pocket 26. Alternatively, the charging pocket 30 may be connected to the interior of the pocket 26 using a zipper, snap, loop and hook, or other fastener.

The pocket 30 has an interior space which may be closed and opened using a fastener 32 such as a zipper, snap, hook and loop, or other fastener. The pocket 30 also may include one or more apertures 34 which allow a cord to pass through. The aperture 34 may be provided at the bottom or rear of the pocket 30, for example, and may be defined by stitching, a grommet, or the like.

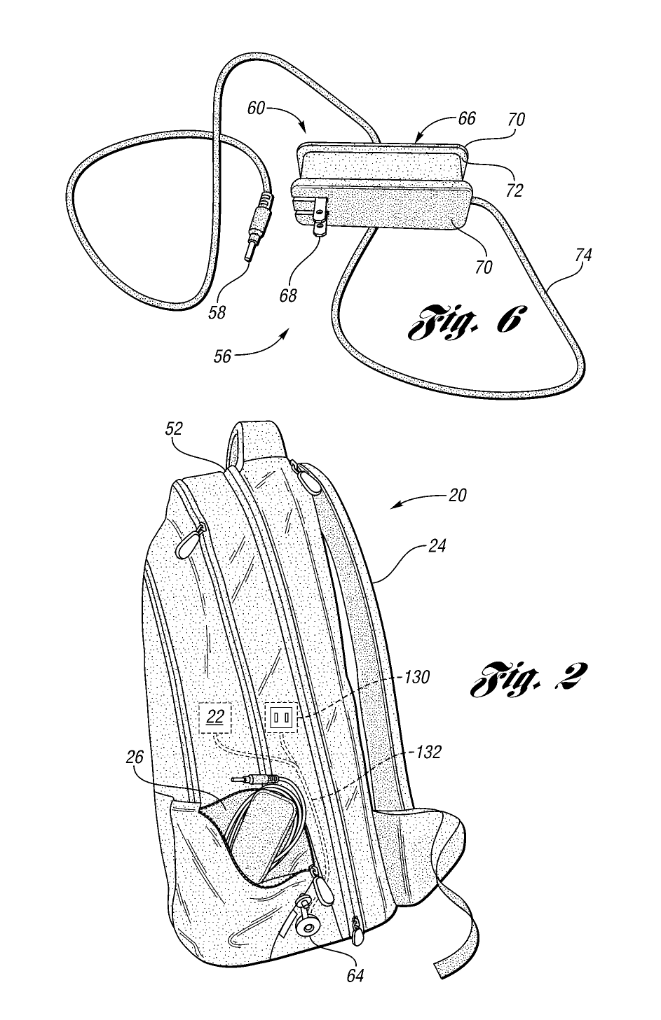

With reference to FIG. 4, the pocket 28 is closed using a fastener such as a zipper, snap, or the like. The pocket 28 may have one or more compartments 36 where mobile electronic devices may be stored. The compartments 36 may be the same size or different sizes, and have a felt, fleece or other lining to protect the mobile devices. Cords 38 with various charging connectors 40 are run from the charging system 22 in the charging pocket 30 through the aperture 34 and internally in the bag 20 to an aperture in the compartments 36. The cords 38 carry electricity for recharging the mobile devices using power in the charging system 22. Various connectors 40 are available for use with the bag, such as USB, mini-USB, micro-USB, and other pin or docking connectors as are known in the art. The compartments 36 may each have a connector pocket 42. The connector 40 fits inside the pocket 42 and may be placed there when it is not connected to a mobile device. The pocket 42 allows the connector 40 to be stored and easily located by the user within the compartment 36.

As shown in FIG. 3, the pocket 26 may also have additional compartments 44 for mobile devices or other personal objects. A compartment 46 is shown sized for a tablet, a netbook, or other device and may have a closure 48 to hold the device in place. The closure 48 is shown as a strap with a hook and loop fastener, although other types of closures and fasteners are contemplated. A clip 50 may be attached to the bag 20 in the pocket 26 and is used to retain a cord for use in charging a mobile device in the compartment 46. The clip 50 may be made from silicone, or another resilient material, such that the cord may be easily put into and removed from the clip 50 by a user. The cord runs from the charging system 22 out of the pocket 30, through the clip 50 and to a device in the compartment 46, or another compartment 44 within the pocket 26.

One or more devices may be charged at a given time within the bag 20 using power from the charging system 22. For example, multiple devices may be placed in compartments in various pockets 26, 28 and connected to the charging system 22 to charge simultaneously. Alternatively, a single device may be charged within the bag 20 by the charging system 22.

The charging system 22, as shown in FIGS. 3 and 5, is sized to be received within the charging pocket 30. The charging system 22 has a battery 52 and a docking station 54. The battery 52 snaps, clips, or otherwise removeably attaches to the docking station 54. The battery 52 is a lithium ion, nickel metal hydride, or other rechargeable battery, and may have a single cell, or multiple cells.

With reference to FIG. 6, a charging apparatus 56 is used to charge the battery 52. The apparatus 56 has a connector 58, a cord 74, and a plug 60. The male connector 58 is sized to fit into a female connector 62 located on the battery 52 (see FIG. 9), or into a female connector 64 located on the bag 20 (see FIG. 2). The plug 60 has a body 66 and a pair of metal prongs 68, and is used with a 110 V or 220 V outlet. The prongs 68 may be folded into the body 66 to create a more compact plug 60 for storage. The body 66 may have a pair of outer plates 70 with an inner portion 72 which creates a circumferential recess on the body 66 to wrap the cord 74 for storage.

The apparatus 56 is shown in a wrapped storage configuration in FIG. 2. An outer pocket 76 may be located on the bag 20 for storage of the apparatus 56. The pocket 76 is shown as adjacent to the female connector 64 for ease of use. The pocket 76 may have a zipper or other fastener to open and close the pocket 76.

In other embodiments, the apparatus 56 has a direct current (DC) connector in place of the metal prongs 68, such that the apparatus 56 may be plugged into a car or other source of DC power for charging the battery 52 in the charging system 22, or for charging of the devices. In some embodiments, the bag 20 is supplied with both styles of apparatuses 56.

The apparatus 56 may be used to charge the battery 52 when the battery 52 is sitting by itself on a counter, table, or the like, by directly plugging the connector 58 into the female connector 62 on the battery 52 (see FIG. 9).

The charging apparatus 56 may be used to charge the battery 52 when the battery 52 is located in the docking station 54 in the bag 20 by plugging the connector 58 into the connector 64 on the bag 20. An internal cord runs from the connector 64 through the interior of the bag 20 and is connected to the docking station 54. Therefore, the charging apparatus 56 can transfer electricity from a wall outlet through the apparatus 56, through the connector 64, through an internal cord in the bag 20, to the docking station 54, and to the battery 52 in the station 54. This allows the battery 52 to be recharged without removing it from the bag 20 and without having to open a bag containing the charging system 22. The user opens the pocket 76 containing the charging apparatus 56, and plugs the plug 60 into a wall outlet, and inserts the connector 58 into the connector 64 on the bag 20. This configuration may also be used to directly charge mobile devices when the mobile devices are being stored within the bag 20 and are connected to the charging system 22 using the respective cords 38, without having to remove devices or open the main pockets and compartments of the bag 20 and permit charging of multiple devices using only one apparatus 56 and one wall outlet.

When the battery 52 has a partial or full charge and is located within the charging system 22, any mobile devices in the bag 20 and connected to the charging system 22 are being charged.

An additional docking station 54 may be available for charging the battery 52 externally to the bag 20, or to charge a spare battery 52 for use with the charging system 22. An additional docking station 54 may be kept at an office or at home, and sit on a desk or a countertop, for example. The use of multiple batteries 52 allows for greater charging of the mobile devices within the bag 20 without access to a wall outlet.

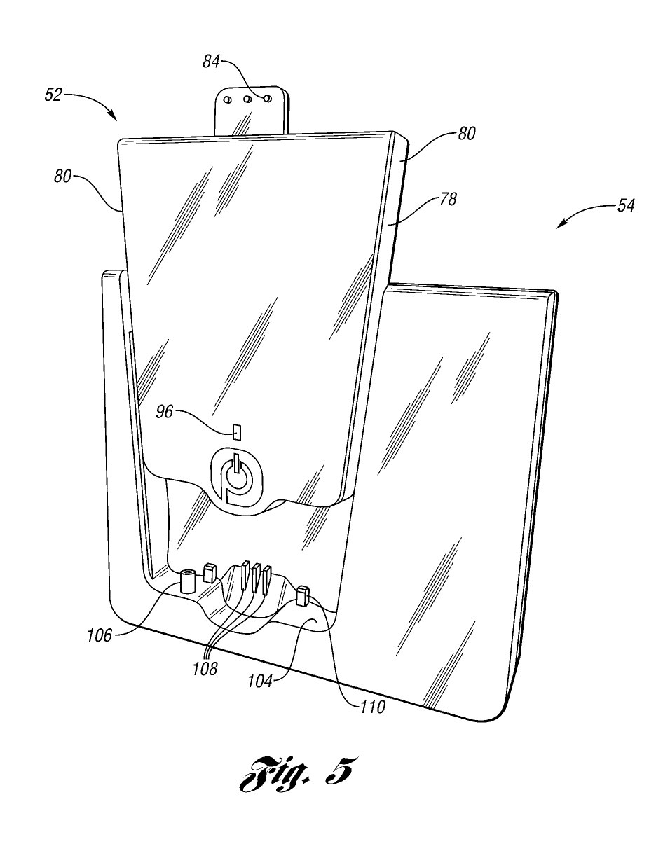

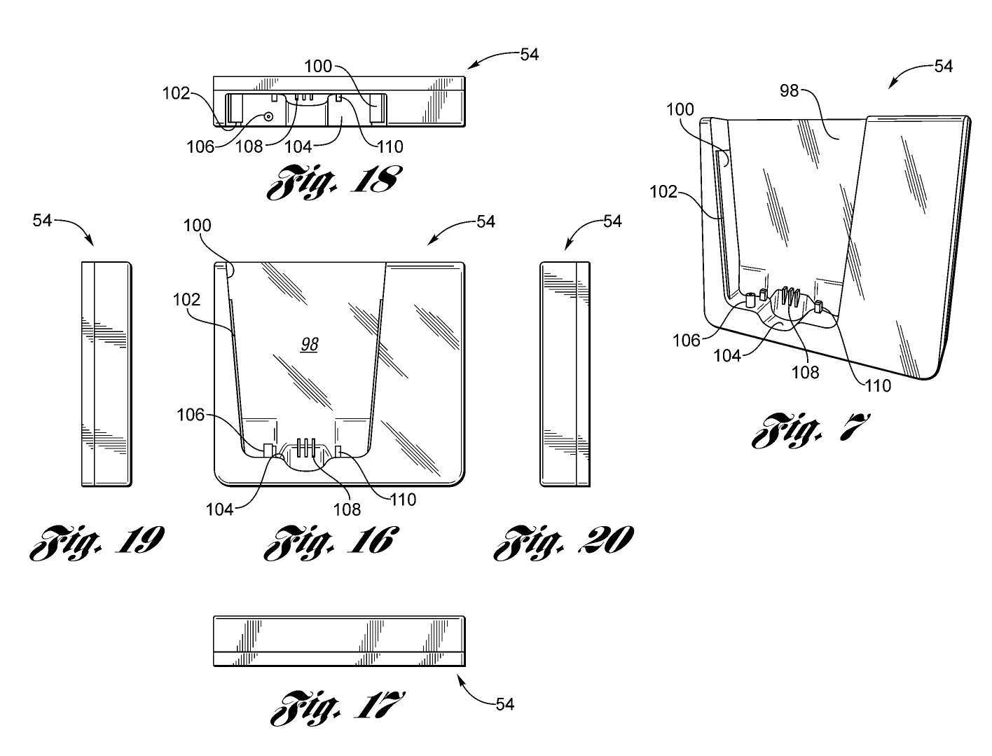

One non-limiting embodiment of the battery 52 is shown in FIGS. 5 and 8-15. The battery 52 may have a body portion 78 with a pair of non-parallel sides 80, which cause the battery 52 to have a tapering or generally trapezoidal appearance. A groove 82 may be located along each side 80. A tab 84 may be connected to the body portion 78 to provide a grasping place for a user when sliding the battery 52 into and out of the docking station 54. The bottom side 86 of the battery 52 may have a contoured surface. A central protrusion 88 may be provided on the battery 52 which mimics or generally corresponds with the shape of a logo.

As shown in FIG. 8, an angled surface 90 may extend from the bottom surface 86 to the back of the body portion 78. Contacts 92 are located on the angled surface 90, and may be an interference type contact interface. A pair of recesses 94 and a female connector 62 are located on the bottom portion 86 of the battery 52 (see FIG. 9). Other shapes and sizes of batteries are contemplated.

Batteries with different storage capacities (e.g. amp hours) may be available for use with the charging system 22. As the capacity of the battery increases, the thickness or length of the battery may increase. For example, either the length or width dimension of the sides 80 of the battery 52 may increase.

As shown in FIG. 5, a light 96 is located on the front of the body portion 78. The light 96 may indicate one color, such as amber, when the battery 52 is being charged and has a partial charge, and indicate another color, such as green, when the battery 52 is being charged and has reached a full charge.

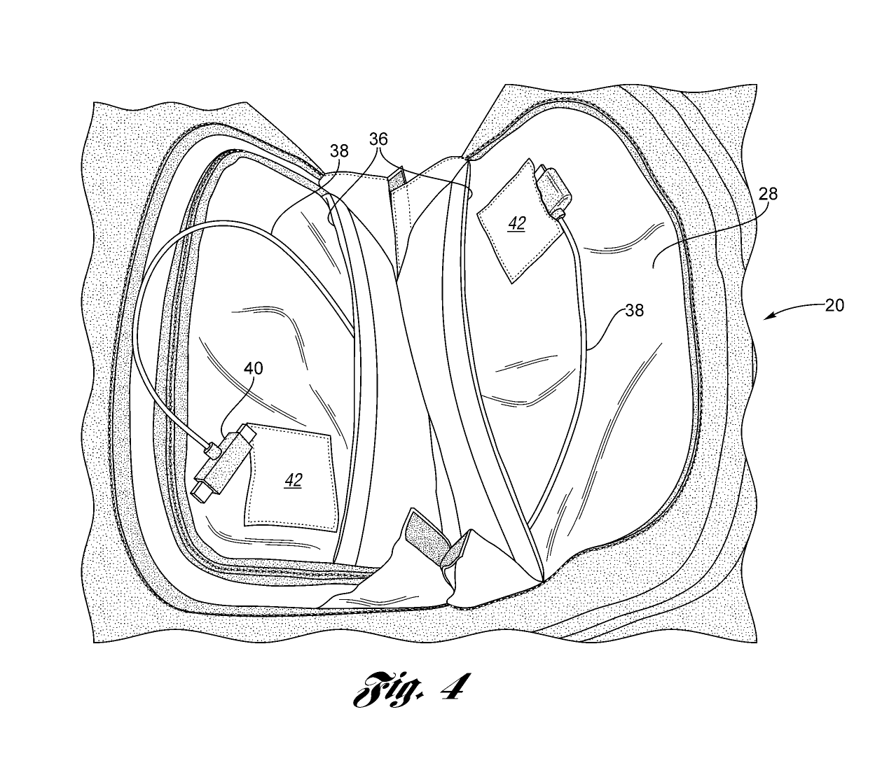

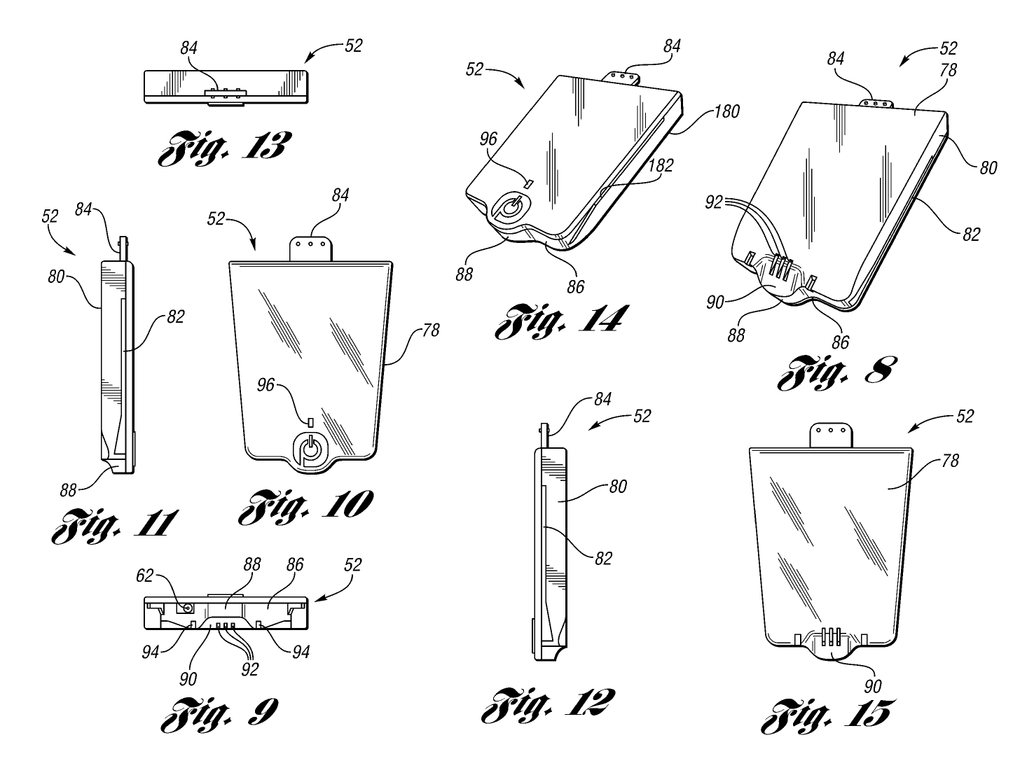

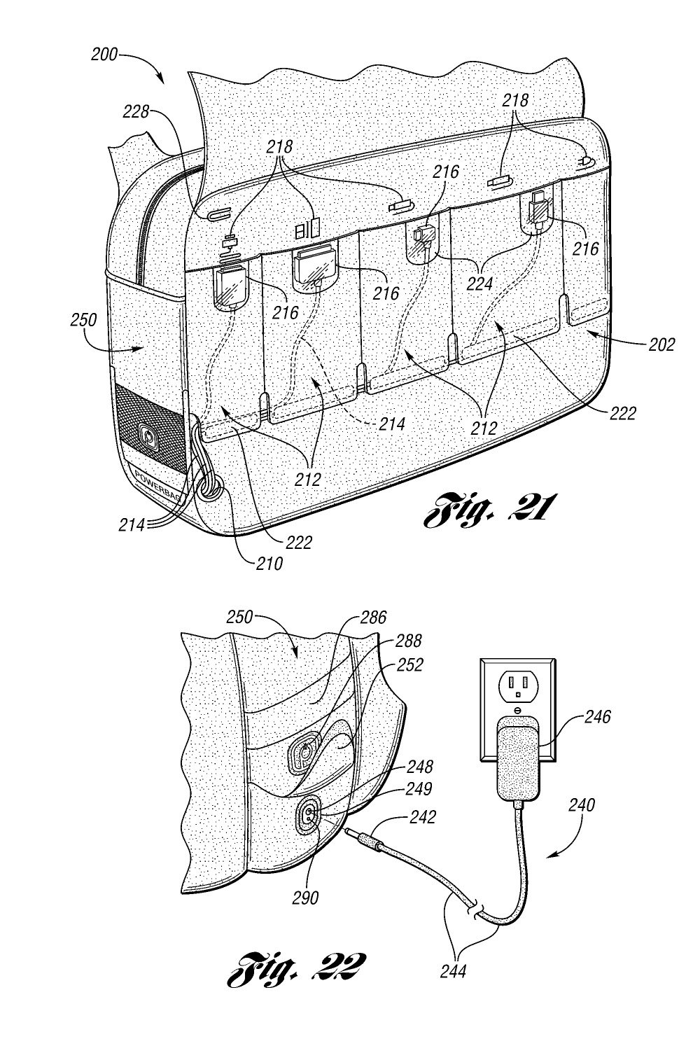

One non-limiting embodiment of the docking station 54 is shown in FIGS. 5, 7, and 16-20. The docking station 54 has a recessed area 98 which is sized to receive the battery 52. The recessed area 98 is defined by a pair of sides 100 which may each have a ridge 102. The angle and spacing of the sides 100 corresponds to the battery 52 sizing and shape. The ridges 102 interact with the grooves 82 such that the battery 52 slides into the recessed area 98 and is constrained to one degree of motion. The bottom surface 104 of the recessed area 98 is contoured to mimic the bottom side 86, protrusion 88, and angled surface 90 of the battery 52. The use of the shaped bottom 86 with the protrusion 88, the angled surface 90, the contacts 92, and the recesses 94 on the battery 52 provide that only specific batteries can fit into the docking station 54. This provides for quality control of the battery 52 and permits the use of batteries with approved voltage and amperage characteristics to be used safely with the charging system 22.

With reference to FIGS. 5 and 9, a connector 106 on the docking station 54 contacts the connector 62 of the battery 52 to electrically connect the battery 52 to the docking station 54 for charging the battery 52 or powering devices. The connector 106 may be a barrel type connector. Contacts 108 on the docking station 54 are in contact with the contacts 92 of the battery 52, such as meshing therewith in an interference fit, to additionally electrically connect the battery 52 to the docking station 54 for charging the battery 52 or powering devices. Locator pins 110 may be provided to interact with the recesses 94 on the battery 52 to additionally locate the battery 52 within the docking station 54. The locator pins 110 may have a circular, rectangular, semi-circular, or other cross section.

In other embodiments, a magnet may be built into the battery 52 with a magnetic switch built into the docking station 54, or vice versa. The magnet activates the switch within the docking station 54 when the battery 52 is slid into the station 54, and only permits charging of the battery 52 and charging of any devices attached to the charging system 22 if the magnetic switch is activated. In other embodiments, an integrated circuit may be placed inside the battery 52 such that the docking station 54 recognizes and only operates with a battery 52 containing the circuit.

A light module 120, shown in FIG. 1, is connected to the charging system 22. The light module 120 has a tactile button 122 and a series of lights 124. The lights 124 are a series of light emitting diodes, or other light sources. Three lights 124 are shown on the bag 20, although any number of lights is contemplated. The lights 124 may be located beneath a mesh panel 126 on the bag 20 such that light from the lights 124 is diffused through the mesh panel 126 and visible to a user.

When a user activates the button 122, the light module 120 checks the amount of the battery charge of a battery 52 in the charging system 22, and various light configurations occur to notify the user of the state of the charging system 22. If there is no battery 52 located within the charging system 22, the lights do not turn on. If there is no charge in the battery 52, the light module 120 may be configured such that the lights 124 do not turn on, or flash a predetermined number of times, or appear as a certain color, such as amber, for a predetermined amount of time, e.g. ten seconds. If there is a partial charge in the battery 52, some of the lights 124 are illuminated to indicate the amount of charge (i.e. one light illuminates out of the three to indicate approximately a one third charge level), and the lights 124 may illuminate as a different color, such as blue. If there is a full charge in the battery 52, all of the lights 124 are illuminated for a predetermined time to indicate a full charge, e.g. three lights illuminate, and the lights 124 may illuminate as a specified color, such as blue. If the button 122 is activated while the charging system 22 is connected to a wall outlet or other external power source, all of the lights 124 may illuminate and flash a number of times, or a scrolling, sequential illumination of the lights 124 may occur.

In other embodiments, a laptop or other device may be placed in another pocket 52, or alternatively into one of the pockets 26, 28, which has been configured to receive one. The laptop may be connected to the charging system 22 using a cord with the appropriate connector, and be charged using pass through charging when the cord is plugged into an external power source.

Alternatively, the bag 20 may contain an alternating current (AC) female plug receptacle 130 within one of the pockets 26, 28, 52, or anywhere else on the bag 20, such that an electronic device power cord, such as a laptop AC power cord, may be plugged into the AC receptacle 130 within the bag 20 and connected to the electronic device, such as the laptop. Alternatively, a camera bag, or AC charger for a camera or camera battery, may be used with the AC receptacle 130. Of course, any AC charger for a device is contemplated for use with the AC receptacle 130. The charging apparatus 56 may connect to the connector 64 when it is plugged into an external power source, such as a AC power outlet, and an internal cord splitter 132 may be provided to route power to the AC receptacle 130 and/or to the charging system 22, such that the laptop or a camera, the battery 52, and/or the other devices may be charged.

The ability to have connectors directly connected to the charging system 22, as well as a AC cord for a device plugged into the AC receptacle 130 provides ease of use for a user. The user can charge multiple devices using the charging system 22 and the AC receptacle 130 without managing cords for multiple devices and without the need for multiple AC wall outlets. The user can charge multiple devices using power in the battery 52 of the charging system 22, or by plugging the bag 20 into a wall outlet using the charging apparatus 56.

Another embodiment of a bag 200 for use with a portable charging system is illustrated in FIGS. 21-25. The bag 200 is shown as a messenger bag, however, any bag or piece of luggage is contemplated, including handbags, backpacks, shoulder bags, roller bags, camera bags, and the like. As with bag 20, the bag 200 may be constructed from a nylon material, although it is contemplated that the bag 20 may be made from leather, or another synthetic material. Other features of bag 20 described above may also be incorporated into bag 200, and features described below for bag 200 may likewise be applicable to bag 20.

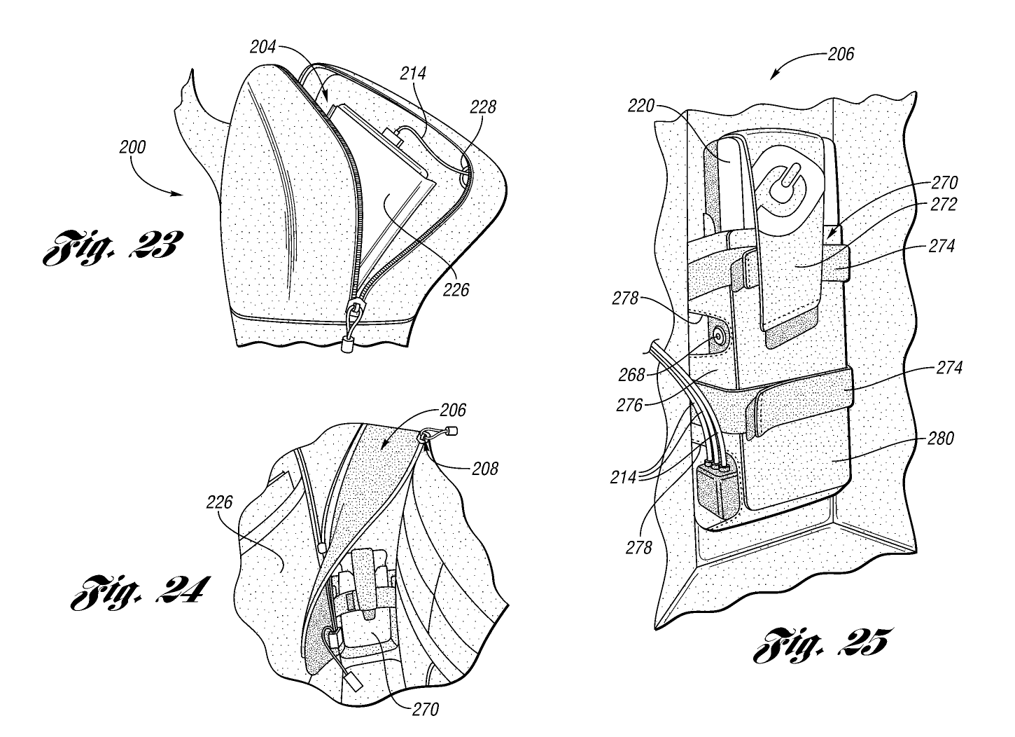

With reference to FIGS. 21 and 23, the bag 200 may include a front pocket or panel 202 and an interior pocket 204, but any number of pockets is contemplated. The interior pocket 204 includes a charging pocket 206 as shown in FIG. 24, such as along a side panel 250 of the bag 200. The charging pocket 206 has an interior space and may be closed and opened using a fastener 208 such as a zipper, snap, hook and loop, magnetic closure, or other fastener. The charging pocket 206 also may include one or more apertures 210 which allow cords to pass through. The aperture 210 may be provided near the bottom of the charging pocket 206, for example, and may be defined by stitching, a grommet, a rubber seal, or the like. A charging system 220, as described below, may be contained within the charging pocket 206.

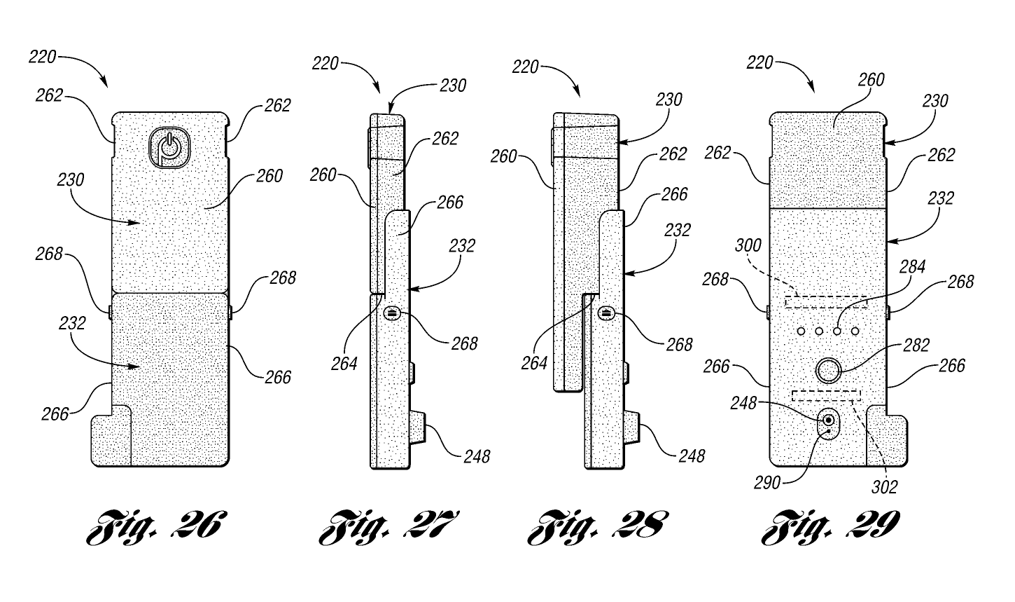

With reference to FIG. 21, the front pocket 202 may have one or more compartments 212 where mobile devices or electronic devices may be stored and charged. The compartments 212 may be the same size or different sizes. The compartments 212 may include identification icons 218 to guide the user as to what type of electronic device is suited for charging in a particular compartment 212. Cords 214 with various charging connectors 216 are run from the charging system 220 (as best shown in FIGS. 26-29) in the charging pocket 206 through the aperture 210 and internally in the bag 200 to the various compartments 212, wherein the cords 214 carry electricity for recharging the electronic devices using power in the charging system 220. Each compartment 212 may include a fastener 222 (e.g., hook and loop) at the bottom thereof which secures the compartment 212 within the front pocket 202 and which allows the charging cords 214 to feed through the compartments 212 along a channel like structure while not obstructing users from taking devices in and out of the compartments 212.

Various connectors 216 are available for use with the bag 200, such as USB, mini-USB, micro-USB, and other pin or docking connectors as are known in the art. In one embodiment, three cords are provided: a cord having a USB female connector, a cord having a 30 pin APPLE connector, and a cord having at least one micro-USB connector (which may be split into 2 micro-USB connectors or a combination micro-USB and mini-USB connector). The compartments 212 may each have a connector pocket 224 sized to receive the connectors 216 when not connected to an electronic device, allowing the connectors 216 to be easily located by a user within the compartment 212. The connector pocket 224 may be constructed from a clear material (e.g., PVC) to allow the connector 216 to show through and be clearly identifiable by a user. Alternatively, the pocket 224 may be fabricated from the same material as the bag 200. A connector anchor, such as clip 50 shown in FIG. 3, may be affixed to the bag 200 and aligned behind the connector pocket 224 for removably receiving the cord 214 and/or connector 216 and holding the connector 216 in place.

As shown in FIG. 23, the interior pocket 204 may have additional compartments for mobile devices or other personal objects, wherein a compartment 226 is shown sized for a tablet, a netbook, or other device. In one embodiment, a USB charging cord 214, which may be the user's own, may be provided to charge their tablet or other mobile device, wherein an opening 228 at the top of the bag 200 allows easy access to the female USB connector 216 that is provided in a compartment 212 in the front pocket 202. Other openings, which may be defined by grommets or the like, may be used to pass cords 214 between pockets for charging devices. Of course, compartments for charging electronic devices could also be provided within interior pocket 204 instead of or in addition to front pocket 202.

As with bag 20, one or more devices may be charged at a given time within the bag 200 using power from the charging system 220. For example, multiple devices may be placed in compartments 212 and pockets 202, 204 and connected to the charging system 220 to charge simultaneously. Therefore, the user can charge multiple devices using the charging system 220 without managing cords for multiple devices and without the need for multiple AC wall outlets.

The charging system 220, best shown in FIGS. 26-29, is sized to be received within the charging pocket 206. The charging system 220 has a battery 230 and a docking station 232. The battery 230 snaps, clips, slides into, or otherwise removably attaches to the docking station 232.

With reference to FIG. 22, a charging apparatus 240 is used to charge the battery 230 when the battery 230 is located in the docking station 232. The charging apparatus 240 has a proximal connector 242, a cord 244, and a distal connector 246 configured to plug into an external power supply, such as a wall outlet. The male connector 242 is sized to be received by a charging port, such as the female connector 248, located on the docking station 232 and arranged to be accessible from an exterior of the bag 200, such as through an aperture 249 in a side panel 250 of the bag 200 (see also FIG. 29). The charging port 248 may be raised or protrude through the aperture 249 to help locate the charging system 220 properly within the charging pocket 206 and for easy access to the port 248. The side panel 250 may include a flap 252 which may be lifted to expose the connector 248 so that the user can plug in the charging apparatus 240 to recharge the battery 230. When finished charging, the user may remove the charging apparatus 240 and close the flap 252, which may include a magnetic closure, hook and loop, or other fastener to secure the flap 252 to the side panel 250.

Therefore, the battery 230 can be recharged without removing it from the bag 200 and without having to open the charging pocket 206 containing the charging system 220, and multiple electronic devices connected to the charging system 220 may be charged without having to remove the devices or open the pockets 202, 204 and compartments 212 of the bag 200. In one embodiment, when the battery 230 has a partial or full charge or is above a predetermined state of charge, and is located within the charging system 220, any electronic devices in the bag 200 and connected to the charging system 220 are charged. When the charging system 220 is connected to the charging apparatus 240, the charging system 220 may charge the devices first, and then the battery 230.

One non-limiting embodiment of a battery 230 for use with bag 200 is shown in FIGS. 26-29. The battery 230 may have a body portion 260 with a pair of sides 262. The docking station 232 has a recessed area 264 defined by a pair of sides 266, wherein the recessed area 264 is sized to receive the battery 230. The battery 230 and docking station 232 may be interlocked upon insertion of the battery 230, after which a release button 268, or other release mechanism, on one or both sides 266 of the docking station 232 may be pressed to allow removal of the battery from the docking station 232. Electrical contacts (not shown) may be located on the battery 230, such as on the bottom surface thereof, which contact corresponding electrical contacts (not shown) on the docking station 232 to electrically connect the battery 230 to the docking station 232 for charging the battery 230 and powering electronic devices. The battery 230 is a lithium ion, lithium polymer, nickel metal hydride, or other rechargeable battery, and may have a single cell, or multiple cells.

Batteries with different storage capacities (e.g., 3000 mAh, 6000 mAh, and 9000 mAh) may be available for use with the charging system 220 and with a single docking station 232. As the capacity of the battery 230 increases, the thickness and/or length of the battery 230 may increase. For example, FIG. 28 depicts a battery 230 of increased storage capacity as compared with the battery 230 depicted in FIG. 27.

Turning now to FIG. 25, an interior of the charging pocket 206 is shown in greater detail. In one embodiment, the charging system 220 is inserted within a restraint pocket 270 having a top flap 272 for keeping the charging system 220 in place. One or more straps 274 may be provided to allow factory assemblers or users to tighten the restraint pocket 270 around the charging system 220 for a secure fit. Due to the variation in thickness between batteries 230 having different storage capacities, the restraint pocket 270 is designed to be adjustable to accommodate these different battery configurations. In one embodiment, the restraint pocket 270 may include a stretchable material 276 on the sides thereof that allows for the insertion of the largest thickness battery 230, where the straps 274 may then be tightened around the inserted charging system 220. Side material 276 may include cut away portions 278 to allow a user access to the release buttons 268 to release the battery 230 for replacement or upgrading, and also for routing of the cords 214. The front portion 280 of the restraint pocket 270 may be constructed from a rigid material to provide protection and rigidity to the charging system 220. With this restraint pocket 270 configuration, the charging system 220 can be inserted after the bag 200 is manufactured, and can be removed for service and replacement if necessary.

As shown in FIG. 29, the docking station 232 includes a battery check button 282 and a series of lights 284. The lights 284 are a series of light emitting diodes, or other light sources. Although four lights 284 are shown, any number of lights is contemplated. With reference to FIG. 22, within the charging pocket 206, the lights 284 may be located along the side panel 250, wherein a portion 286 of the side panel 250 aligned with the lights 284 may be constructed from a mesh panel or the like such that the lights 284 are visible to a user. The battery check button 282 may be aligned with a corresponding button 288 or tactile overlay, such as a molded rubber logo, on the side panel 250 and may be depressed through the bag 200.

When a user presses the battery check button 282, a light module 300 in communication with the charging system 220 initiates various configurations of lights 284 to notify the user of the state of charge of the charging system 220. If there is no charge in the battery 230, the lights 284 may not turn on. If there is a partial charge in the battery 230, some of the lights 284 may be illuminated to indicate the amount of charge (i.e., two lights illuminate out of the four to indicate approximately a one half charge level of the battery 230). If there is a full charge in the battery 230, all of the lights 284 may be illuminated for a predetermined time to indicate a full charge. If the battery check button 282 is pressed while the charging system 220 is connected to a wall outlet or other external power source, all of the lights 284 may illuminate and flash a number of times, or a scrolling, sequential illumination of the lights 284 may occur. In one example, lights 284 indicating the charge level may illuminate constantly, while lights 284 indicating the remaining amount of the battery 230 to be charged may sequentially illuminate intermittently until the next charging level is complete. Of course, other light displays are also contemplated.

The battery check button 282 may also be used to turn the charging system 220 on or off, and may require the user activating the button 282 for a predetermined period of time to prevent accidental activation. If the battery check button 282 is pressed to turn the charging system 220 on or off, all or some of the lights 284 may illuminate for a period of time or flash a number of times, or a scrolling, sequential illumination of the lights 284 may occur.

According to an embodiment, either bag 20 or bag 200 may be configured to provide a user with an audio notification of charging status, for example when the charging system 220 of the bag 20, 200 is powered on or off, when a device is connected to or disconnected from the bag 20, 200, a charging status of the battery in the charging system 220, and even an indication of the specific type of device that is being charged or the connector 218 that power is flowing through.

An audio notification module 302 in communication with the charging system 220 may initiate a tone or series of tones, a voice statement, or a combination of the two in response to different charging events. The audio notification module 302 has a speaker module to audibly broadcast the notification. The events triggering audio notification and exemplary tones and voice scripts can include, but are not limited to, the following: 1) when the bag 20, 200 is plugged into an input source (e.g., “Charging Powerbag”); 2) when the bag 20, 200 is unplugged from an input source (e.g., “Charging disconnected”); 3) when the bag 20, 200 is fully charged (e.g., “Charging complete”); 4) when the bag 20, 200 is turned on (e.g., a technology sound such as a series of tones indicating the product brand); 5) when the bag 20, 200 is turned off (e.g., “Powering off”); 6) when the battery check button is pressed and the battery is 1-25% charged (e.g., “Low battery, please recharge”), 26-50% charged (e.g., “Battery is below 50%”), 51-75% charged (e.g., “Battery is above 50%”), 76-99% charged (e.g., “Battery is near full”), and 100% (e.g., “Battery is full”); 7) when the bag 20, 200 is turned on with devices already connected (e.g., “Charging initiated”); 8) when a mini- or micro-USB device is connected to the bag 20, 200 (e.g., “Charging mini/micro device”); 9) when a USB device is connected to the bag 20, 200 (e.g., “Charging USB device”); and 10) when an APPLE device is connected to the bag 20, 200 (e.g., “Charging APPLE device”). With reference to examples 8-10 above, a tone or series of tones may also be provided which is unique to the manufacturer or service provider of the device. Such an audio notification not only provides the user with an indication of the specific type of device being charged, but also serves as a vehicle for advertising the services of others.

In addition, the tones or voice prompts could be user-selectable either through stored customizable sounds in the charging system 220 or audio notification module 302, or downloaded or wirelessly transmitted to the charging system 220 or audio notification module 302 by a user. In one embodiment, the devices begin charging only after all audio notification by the bag 20, 200 is complete so that the device sounds do not interfere with the information being conveyed by the bag 20, 200. Different languages, accents, or gender may be selected for voice scripts from the audio notification module 302. The audio notification feature may be switched on and off by a user, such as via engagement of a tool with a micro hole 290 on the docking station (see FIG. 29). A portion of the audio notification may be switched off, such that the tones are on and the voice scripts are off, or vice versa. Notification lights may be provided to indicate to the user whether the tones and/or the voice notifications are on. The audio notification module 302 may also include a volume selection input to increase, decrease, or mute the audio notifications.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A portable system for charging an electronic device, comprising:
a bag;
a charging system located within the bag;
at least one cord having a connector in electrical communication with the charging system, the connector for charging an electronic device; and
an audio notification module in communication with the charging system for indicating a charging status of at least one of the charging system and the electronic device.

2. The system of claim 1, wherein the audio notification module indicates a charging status via a tone.

3. The system of claim 1, wherein the audio notification module indicates a charging status via a voice script.

4. The system of claim 1, wherein the audio notification module indicates a state of charge of the charging system.

5. The system of claim 1, further comprising a charging apparatus having a distal connector configured to plug into an external power supply and a proximal connector configured to connect to the charging system for providing power to the charging system.

6. The system of claim 5, wherein the audio notification module audibly indicates a connection of a charging apparatus to the charging system.

7. The system of claim 1, wherein the audio notification module audibly indicates a connection of the electronic device to the charging system.

8. The system of claim 7, wherein the audio notification module is configured to provide the audible indication before the charging system provides power to the electronic device.

9. The system of claim 7, wherein the audio notification module identifies a type of the electronic device.

10. The system of claim 1 wherein the audio notification module is initiated using a user interface.

11. The system of claim 1 wherein at least one of a tone and a voice script is customizable by a user.

12. The system of claim 1 wherein the charging system has a docking station for releasably docking a battery.

13. A portable system for charging an electronic device, comprising:
a bag;
a charging system located within the bag, the charging system having a charging port accessible from an exterior of the bag;
a charging apparatus having a distal connector configured to plug into an external power supply and a proximal connector configured to connect to the charging port through the bag to provide power to the charging system for charging the charging system; and
at least one cord having a connector in electrical communication with the charging system, the connector for charging an electronic device.

14. The system of claim 13, wherein the bag includes a compartment sized to receive the electronic device.

15. The system of claim 14, wherein the compartment includes a connector pocket for receiving and securing the connector when not in use.

16. The system of claim 14, wherein the bag includes an icon adjacent the compartment to indicate the connector associated with the compartment.

17. The system of claim 13, wherein the bag includes an interior pocket for housing the charging system.

18. The system of claim 13 wherein the charging system further comprises:
a battery; and
a docking station for receiving the battery, the docking station supporting the charging port.

19. A portable system for charging an electronic device, comprising:
a bag;
a charging system located within the bag, the charging system having a docking station for releasably docking a battery, the charging system including a battery check button accessible from an exterior of the bag and lights visible from an exterior of the bag;
a light module in communication with the charging system, wherein upon activation of the battery check button by a user, the light module is configured to illuminate the lights to provide information regarding a state of charge of the charging system; and
at least one cord having a connector in electrical communication with the charging system, the connector for charging an electronic device.

20. The system of claim 19 further comprising an audio notification module in communication with the charging system for indicating a charging status of at least one of the battery and the electronic device.
